(19) United States
(12) Patent Application Publication
(10) Pub. No.: US 2018/0333994 A1
(43) Pub. Date: Nov. 22, 2018

(54) Pneumatic Tire Assembly

(71) Applicant: Peram LLC, Lancaster, PA (US)

(72) Inventors: Tan Hoa Nguyen, Lancaster, PA (US); Anh Dung Nguyen, Virginia Beach, VA (US)

(73) Assignee: Peram LLC, Lancaster, PA (US)

(21) Appl. No.: 15/600,212

(22) Filed: May 19, 2017

(51) Int. Cl. B60C 19/12; C08L 9/06; C08L 23/16; C08J 9/26; C08L 11/00; C08L 7/00

(52) U.S. Cl. CPC B60C 19/127; B60C 2200/10; C08L 23/16; C08J 9/26; C08L 11/00; C08L 7/00; C08J 2203/184; C08J 2203/04; C08J 2309/06; C08J 2323/16; C08J 2407/00; C08J 2409/06; C08J 2409/02; C08J 2311/00; C08J 2307/00; C08L 2205/03; C08L 9/06

(57) ABSTRACT

A pneumatic tire assembly is provided and includes an annular tire, an annular inflatable inner tube, and an annular solid insulation tube. The annular inflatable inner tube is positioned within the annular tire. The annular solid insulation tube is positioned between the annular tire and the annular inflatable inner tube and includes an outer surface in contact with an inner surface of the annular tire and an inner surface in contact with an outer surface of the annular inflatable inner tube.

### FIELD OF THE INVENTION

The present invention relates, in general, to pneumatic tire assembly and, in particular, to a pneumatic tire assembly having a solid insulation tube receiving positioned along an inner surface thereof and receiving an annular inflatable inner tube to protect against failure caused, for example, by puncture of the inner tube by a sharp object.

### BACKGROUND

In a conventional pneumatic tire having an inflatable inner tube, the outer surface of the inflatable inner tube is in contact with the inner surface of the annular tire of the annular tire that makes contact with the surface that the annular tire rolls over. When the annular tire rolls over a sharp object, such as a nail, and the sharp object penetrates the annular tire of the annular tire, often the sharp object passes completely through the annular tire and punctures the inner tube, resulting in the annular tire deflating and failing. The present invention mitigates the adverse effect of a puncture of the inner tube by a sharp foreign object that penetrates the annular tire.

### SUMMARY

A pneumatic tire assembly is provided and includes an annular tire, an annular inflatable inner tube, and an annular solid insulation tube. The annular inflatable inner tube is positioned within the annular tire. The annular solid insulation tube is positioned between the annular tire and the annular inflatable inner tube and includes an outer surface in contact with an inner surface of the annular tire and an inner surface in contact with an outer surface of the annular inflatable inner tube.

### BRIEF DESCRIPTION OF THE DRAWINGS

The invention will now be described by way of example with reference to the accompanying Figures of which:

FIG. 1 is perspective view of a pneumatic tire assembly mounted on a conventional wheel;

FIG. 2 is an exploded perspective view of a pneumatic tire assembly constructed in accordance with the present invention, prior to assembly, and a conventional wheel on which the pneumatic tire assembly is mounted;

FIG. 3 is a close-up perspective of the pneumatic tire assembly of FIG. 1; and

FIG. 4 is a cross-section view of the pneumatic tire assembly of FIG. 3 taken along line 4-4.

### DETAILED DESCRIPTION OF THE EMBODIMENT(S)

Referring to the Figures, a pneumatic tire assembly, constructed in accordance with the present invention, generally includes an annular tire 10, an annular inflatable inner tube 20, and an annular solid insulation tube 30.

When assembled, the annular tire 10, the annular inflatable inner tube 20, and the annular solid insulation tube 30 are mounted on a wheel 40.

In an exemplary embodiment of the invention, the annular tire 10 is a formed of rubber, carbon black and other materials using calendaring, extrusion, and bead building processes.

As shown in FIG. 4, the annular tire 10 includes an outer surface 10a and an inner surface 10b. For the embodiment of the present invention being described and illustrated, the outer surface of annular tire 10 has a first section 12 that is treaded and a second section 14 that is even and continuous, namely unthreaded, which makes up a sidewall of the annular tire 10. Furthermore, as shown in FIG. 4, the annular tire 10 may include a bead section 16 having a high tensile-strength steel wire that is encased in a rubber body. One skilled in the art should appreciate that the annular tire may be formed using a ply construction.

As shown in FIG. 4, the annular inflatable inner tube 20 is a conventional inner tube which snugly connects to the inner surface of the annular tire 10 by pressure. The annular inflatable inner tube 20 generally includes an elastomeric hollow body 22 and a valve 24 that is hermetically sealed to the body 22 and allows ingress and egress of air into the elastomeric hollow body 22. The annular inflatable inner tube 20 is positionable within annular tire 10 and generally includes an inner surface 20a and an outer surface 20b.

Still referring to FIG. 4, the annular solid insulation tube 30 includes a solid body 32 made from an insulation rubber composition. The solid body 32 generally includes an inner surface 30a and an outer surface 30b. In an exemplary embodiment of the invention, the solid insulation tube 30 includes an inner wall receiving section 34 positioned along the outer surface 30b and an inner tube receiving section 36 positioned along the inner surface 30a and extending into the solid body 32. In the shown embodiment, the inner wall receiving section and the inner tube receiving section 36 are hemispherical. In an exemplary embodiment of the invention, the inner tube receiving section includes a top wall 36a and a pair of side walls 36b that are angled toward each other in the shown embodiment.

According to the invention, the insulation rubber composition generally includes a first elastomer, a second elastomer, carbon black, a plasticizer, one or more blowing agents, and a filler.

In an exemplary embodiment of the invention, the insulation rubber composition includes a proportion of 15.97-34.71 wt % of a first elastomer, 8.37-16.22 wt % of a second elastomer, 13.29-23.00 wt % of carbon black, 13.71-20.02 wt % of a plasticizer, 3.22-5.11 wt % of a blowing agent; a filler and incidental impurities complete the balance of the composition.

In particular, in an exemplary embodiment of the invention, the insulation rubber composition includes a combination of elastomers. More particularly, the insulation rubber composition includes a combination of saturated and unsaturated rubbers. In the described embodiment, the insulation rubber composition includes a combination of the following group of elastomers, including ethylene propylene diene monomer rubber (EPDM), natural polyisoprene rubber, chloroprene rubber (CR), styrene-butadiene rubber (SBR), and nitrile rubber (NBR). However, one skilled in the art should appreciate that a combination of other saturated and unsaturated rubbers may be possible.

In the proposed insulation rubber composition, an elastomer, such as EPDM, is used to enhance heat-, ozone-, and weather-resistance, as well as electrical insulating properties. In the proposed insulation rubber composition, an addition of a second elastomer, such as, natural polyisoprene rubber, is used to enhance elasticity of the insulation rubber composition.

In particular, in an exemplary embodiment of the invention, the insulation rubber composition includes a first elastomer having a wt % range of 15.97-34.71%. In another exemplary embodiment of the invention, the insulation rubber composition includes a first elastomer having a wt % range of 15.97-20.73%. In yet another exemplary embodiment of the invention, the insulation rubber composition includes a first elastomer having a wt % range of 20.47-20.73%.

In particular, in an exemplary embodiment of the invention, the insulation rubber composition includes the second elastomer having a wt % range of 8.37-16.22%. In another exemplary embodiment of the invention, the insulation rubber composition includes the second elastomer having a wt % range of 11.46-16.22%.

In the proposed insulation rubber composition, carbon black is used as a pigment and reinforcing material. In addition, the carbon black can be used to reduce thermal damage and product viability.

In particular, in an exemplary embodiment of the invention, the insulation rubber composition includes carbon black having a wt % range of 13.29-23.00%. In another exemplary embodiment of the invention, the insulation rubber composition includes carbon black having a wt % range of 22.41-22.80%. Moreover, in yet another exemplary embodiment of the invention, the insulation rubber composition includes carbon black having a wt % of 22.53%.

In the proposed insulation rubber composition, one or more plasticizers are used to increase the plasticity. In the proposed insulation rubber composition, one or more plasticizers is also used a softener, extender, and lubricant for manufacturing of product from the insulation rubber composition, including an airless tube for a tire. In particular, in an exemplary embodiment of the invention, the insulation rubber composition may include a combination of plasticizers, including paraffinic oil and stearic acid.

In particular, in an exemplary embodiment of the invention, the insulation rubber composition includes one or more plasticizers having a wt % range of 13.71-20.02%. In another exemplary embodiment of the invention, the insulation rubber composition includes plasticizer having a wt % range of 19.00-20.02%. Moreover, in yet another exemplary embodiment of the invention, the insulation rubber composition includes one or more plasticizers having a wt % of 19.88%.

In the proposed insulation rubber composition, one or more blowing agents may be used to produce a cellular structure that reduces density, increases thermal and acoustic insulation, and increases relative stiffness. In particular, in an exemplary embodiment of the invention, the insulation rubber composition may include one or more blowing agents, including calcium oxide (CaO) and azodicarbonamide (ACD).

In an exemplary embodiment of the invention, the insulation rubber composition includes one or more blowing agents having a wt % range of 3.22-5.11%. In another exemplary embodiment of the invention, the insulation rubber composition includes one or more blowing agents having a wt % range of 3.53-3.55%. In addition, in yet another exemplary embodiment of the invention, the insulation rubber composition includes one or more blowing agents having a wt % of 3.54%.

In the proposed insulation rubber composition, filler is used to complete the composition with respect to the other parts. In particular, in an exemplary embodiment of the invention, the insulation rubber composition may include calcium carbonate as a filler. In the proposed insulation rubber composition, calcium carbonate may have a wt % range of 15.97-17.48%. In another exemplary embodiment of the invention, the insulation rubber composition includes filler having a wt % range of 15.97-16.22%.

The insulation rubber composition according to the invention also includes a curing agent and an antioxidant agent.

In another exemplary embodiment of the invention, the proposed insulation rubber composition includes a proportion of 15.97-34.71 wt % of a first elastomer, 8.37-16.22 wt % of a second elastomer, 13.29-23.00 wt % of carbon black, 13.71-20.02 wt % of a plasticizer, 3.22-5.11 wt % of a blowing agent, 5.57-6.71 wt % of a curing agent, 0.15-0.44 wt % of an antioxidant, and filler completing the composition.

In the proposed insulation rubber composition, the curing agent is used to toughen or harden the overall composition by cross-linking of polymer chains, using processes such as vulcanization. In an exemplary embodiment of the invention, the insulation rubber composition may include one or more curing agents, including zinc oxide, n-cyclohexyl-2-benzothiazole sulfenamide (CBS), diphenylguanidine (DPG), and sulfur (S).

In the proposed insulation rubber composition, one or more curing agents may have a wt % range of 5.57-6.71%. In another exemplary embodiment of the invention, the insulation rubber composition includes one or more curing agents having a wt % range of 5.57-5.62%.

In the proposed insulation rubber composition, the antioxidant is used to prevent oxidation. In an exemplary embodiment of the invention, the insulation rubber composition may include one or more antioxidants, including butylated hydroxytoluene (BHT) and/or 2,2,4-trimethyl-1,2-dihydroquinoline polymer (TMQ).

In the proposed insulation rubber composition, one or more antioxidants may have a wt % range of 0.15-0.44%. In another exemplary embodiment of the invention, the insulation rubber composition includes one or more antioxidants having a wt % range of 0.15-0.17%. In yet another exemplary embodiment of the invention, the insulation rubber composition includes one or more antioxidants having a wt % range of 0.42-0.44%.

The present invention can be illustrated by the following examples without being limited by them. Each of the following examples was prepared being dependent on a required size of the annular tire 10 according to the invention.

Table 1 shows an exemplary embodiment of the insulation rubber composition.

TABLE 1
Exemplary Insulation Rubber Composition

| Component | Wt % |
|---|---|
| 1st Elastomer | 16.10% |
| 2nd Elastomer | 16.10% |
| Carbon Black | 22.53% |
| Filler | 16.10% |
| Plasticizer | 19.88% |
| Curing Agent | 5.60% |
| Blowing Agent | 3.54% |
| Antioxidant | 0.16% |

Table 2 shows another exemplary embodiment of the insulation rubber composition according to the invention.

TABLE 2
Exemplary Insulation Rubber Composition

| Additive | Component | Wt % |
|---|---|---|
| Ethylene Propylene Diene Monomer rubber | 1st Elastomer | 16.10% |
| (EPDM) | | |
| Styrene Butadiene Rubber (SBR) | 2nd Elastomer | 16.10% |
| Carbon Black | Carbon Black | 22.53% |
| Calcium Carbonate | Filler | 16.10% |
| Paraffin Oil | Plasticizer | 19.31% |
| Stearic Acid | Plasticizer | 0.57% |
| Zinc Oxide | Curing Agent | 3.22% |
| N-Cyclohexyl-2-Benzothiazole Sulfenamide | Curing Agent | 1.06% |
| (CBS or CZ) | | |
| Diphenylguanidine (DPG) | Curing Agent | 0.68% |
| Sulfur (S) | Curing Agent | 0.64% |
| Calcium Oxide (CaO) | Blowing Agent | 0.32% |
| Azodicarbonamide (ACD) | Blowing Agent | 3.22% |
| Butylated hydroxytoluene (BHT) | Antioxidant | 0.16% |

Table 3 shows another exemplary embodiment of the insulation rubber composition according to the invention.

TABLE 3
Exemplary Insulation Rubber Composition

| Component | Wt % |
|---|---|
| 1st Elastomer | 20.60% |
| 2nd Elastomer | 11.59% |
| Carbon Black | 22.53% |
| Filler | 16.10% |
| Plasticizer | 19.88% |
| Curing Agent | 5.60% |
| Blowing Agent | 3.54% |
| Antioxidant | 0.16% |

Table 4 shows an exemplary embodiment of the insulation rubber composition according to the invention.

TABLE 4
Exemplary Insulation Rubber Composition

| Additive | Component | Wt % |
|---|---|---|
| Ethylene Propylene Diene Monomer rubber | 1st Elastomer | 20.60% |
| (EPDM) | | |
| Natural Rubber (NR) | 2nd Elastomer | 11.59% |
| Carbon Black | | 22.53% |
| Calcium Carbonate | Filler | 16.10% |
| Paraffin Oil | Plasticizer | 19.31% |
| Stearic Acid | Plasticizer | 0.57% |
| Zinc Oxide | Curing Agent | 3.22% |
| N-Cyclohexyl-2-Benzothiazole Sulfenamide | Curing Agent | 1.06% |
| (CBS or CZ) | | |
| Diphenylguanidine (DPG) | Curing Agent | 0.68% |
| Sulfur (S) | Curing Agent | 0.64% |
| Calcium Oxide (CaO) | Blowing Agent | 0.32% |
| Azodicarbonamide (ACD) | Blowing Agent | 3.22% |
| Butylated hydroxytoluene (BHT) | Antioxidant | 0.16% |

Table 5 shows another exemplary embodiment of the insulation rubber composition according to the invention.

TABLE 5
Exemplary Insulation Rubber Composition

| Component | Wt % |
|---|---|
| 1st Elastomer | 20.60% |
| 2nd Elastomer | 11.59% |
| Carbon Black | 22.53% |
| Filler | 16.10% |
| Plasticizer | 19.88 |
| Curing Agent | 5.60% |
| Blowing Agent | 3.54% |
| Antioxidant | 0.16% |

Table 6 shows another exemplary embodiment of the insulation rubber composition according to the invention.

TABLE 6
Exemplary Insulation Rubber Composition

| Additive | Component | Wt % |
|---|---|---|
| Ethylene Propylene Diene Monomer rubber | 1st Elastomer | 20.60% |
| (EPDM) | | |
| Styrene Butadiene Rubber (SBR) | 2nd Elastomer | 11.59% |
| Carbon Black | | 22.53% |
| Calcium Carbonate | Filler | 16.10% |
| Paraffin Oil | Plasticizer | 19.31% |
| Stearic Acid | Plasticizer | 0.57% |
| Zinc Oxide | Curing Agent | 3.22% |
| N-Cyclohexyl-2-Benzothiazole Sulfenamide | Curing Agent | 1.06% |
| (CBS or CZ) | | |
| Diphenylguanidine (DPG) | Curing Agent | 0.68% |
| Sulfur (S) | Curing Agent | 0.64% |
| Calcium Oxide (CaO) | Blowing Agent | 0.32% |
| Azodicarbonamide (ACD) | Blowing Agent | 3.22% |
| Butylated hydroxytoluene (BHT) | Antioxidant | 0.16% |

Table 7 shows an exemplary embodiment of the insulation rubber composition according to the invention.

TABLE 7
Exemplary Insulation Rubber Composition

| Component | Wt % |
|---|---|
| 1st Elastomer | 34.47% |
| 2nd Elastomer | 8.62% |
| Carbon Black | 13.54% |
| Filler | 17.23% |
| Plasticizer | 13.97% |
| Curing Agent | 6.65% |
| Blowing Agent | 5.09% |
| Antioxidant | 0.43% |

Table 8 shows an exemplary embodiment of the insulation rubber composition according to the invention.

TABLE 8
Exemplary Insulation Rubber Composition

| Additive | Component | Wt % |
|---|---|---|
| Chloroprene Rubber (CR) | 1st Elastomer | 34.47% |
| Nitrile Rubber (NBR) | 2nd Elastomer | 8.62% |
| Carbon Black | Carbon Black | 13.54% |
| Calcium Carbonate | Filler | 17.23% |
| Paraffin Oil | Plasticizer | 13.54% |
| Stearic Acid | Plasticizer | 0.43% |
| Zinc Oxide | Curing Agent | 4.31% |
| Magnesium Oxide (MgO) | Curing Agent | 1.72% |
| N-Cyclohexyl-2-Benzothiazole Sulfenamide | Curing Agent | 0.54% |
| (CBS or CZ) | | |
| Diphenylguanidine (DPG) | Curing Agent | 0.09% |
| Sulfur (S) | Blowing Agent | 0.78% |
| Azodicarbonamide (ACD) | Blowing Agent | 4.31% |
| 2,2,4-Thimethyl-1,2-Dihydroquinoline | Antioxidant | 0.43% |
| Polymer (TMQ) | | |

In another embodiment of the invention, a rubber composition is provided and includes a first elastomer, a second elastomer, a third elastomer, carbon black, a plasticizer, a blowing agent, a filler, a curing agent, and an anti-oxidant agent. The first elastomer is provided in a range of 14.00-15.00 wt %, the second elastomer is provided in a range of 14.00-15.00 wt %, and the third elastomer is provided in a range of 11.00-12.00 wt %. Carbon black is provided in the range of 20.00-23.00 wt %. The plasticizer is provided in a range of 13.70-20.10 wt %. The blowing agent is provided in a range of 4.20-4.40 wt %. The curing agent is provided in a range of 4.50-4.80 wt %. Filler and incidental impurities and elements may be used to complete the composition.

In another exemplary embodiment, a rubber composition according to the invention includes a first elastomer, a second elastomer, a third elastomer, carbon black, a plasticizer, a blowing agent, a filler, a curing agent, and an anti-oxidant agent according to the invention includes a first elastomer, a second elastomer, carbon black, a plasticizer, one or more blowing agents, and a filler.

In an exemplary embodiment of the invention, the insulation rubber composition includes a proportion of 14.00-15.00 wt % of a first elastomer, 14.00-15.00 wt % of a second elastomer, 11.00-12.00 wt % of a third elastomer, 20.00-22.00 wt % of carbon black, 15.50-16.50 wt % of a plasticizer, 4.00-4.50 wt % of a blowing agent, 4.50-5.00 wt % of a curing agent, and a filler completing the composition.

In particular, in an exemplary embodiment of the invention, the insulation rubber composition includes a combination of elastomers. More particularly, the insulation rubber composition includes a combination of saturated and unsaturated rubbers. In the described embodiment, the insulation rubber composition includes a combination of the following group of elastomers, including ethylene propylene diene monomer rubber (EPDM), natural polyisoprene rubber, chloroprene rubber (CR), styrene-butadiene rubber (SBR), high styrene rubber (HSR) and nitrile rubber (NBR). However, one skilled in the art should appreciate that a combination of other saturated and unsaturated rubbers may be possible.

In the proposed insulation rubber composition, an elastomer, such as EPDM, is used to enhance heat-, ozone-, and weather-resistance, as well as electrical insulating properties. In the proposed insulation rubber composition, an addition of a second elastomer, such as natural polyisoprene rubber, is used to enhance elasticity of the insulation rubber composition. In the proposed insulation rubber composition, an addition of a third elastomer, such as HSR, is used to enhance processing, abrasion resistance, tear resistance, and flex resistance.

In particular, in an exemplary embodiment of the invention, the insulation rubber composition includes a first elastomer having a wt % range of 14.00-15.00%. In another exemplary embodiment of the invention, the insulation rubber composition includes a first elastomer having a wt % range of 14.24-14.32%. In yet another exemplary embodiment of the invention, the insulation rubber composition includes a first elastomer having a wt % range of 14.26-14.30%.

In particular, in an exemplary embodiment of the invention, the insulation rubber composition includes a second elastomer having a wt % range of 14.00-15.00%. In another exemplary embodiment of the invention, the insulation rubber composition includes a second elastomer having a wt % range of 14.24-14.32%. In yet another exemplary embodiment of the invention, the insulation rubber composition includes a second elastomer having a wt % range of 14.26-14.30%.

In particular, in an exemplary embodiment of the invention, the insulation rubber composition includes a third elastomer having a wt % range of 11.00-12.00%. In another exemplary embodiment of the invention, the insulation rubber composition includes a first elastomer having a wt % range of 11.39-11.45%. In yet another exemplary embodiment of the invention, the insulation rubber composition includes a first elastomer having a wt % range of 11.41-11.43%.

In the proposed insulation rubber composition, carbon black is used as a pigment and reinforcing material. In addition, the carbon black can be used to reduce thermal damage and product viability.

In particular, in an exemplary embodiment of the invention, the insulation rubber composition includes carbon black having a wt % range of 20.00-23.00%. In another exemplary embodiment of the invention, the insulation rubber composition includes carbon black having a wt % range of 20.57-20.67%. Moreover, in yet another exemplary embodiment of the invention, the insulation rubber composition includes carbon black having a wt % of 20.59-20.65%.

In the proposed insulation rubber composition, one or more plasticizers are used to increase the plasticity. In the proposed insulation rubber composition, one or more plasticizers is also used a softener, extender, and lubricant for manufacturing of product from the insulation rubber composition, including an airless tube for a tire. In particular, in an exemplary embodiment of the invention, the insulation rubber composition may include a combination of plasticizers, including paraffinic oil and stearic acid.

In particular, in an exemplary embodiment of the invention, the insulation rubber composition includes one or more plasticizers having a wt % range of 13.70-20.10%. In another exemplary embodiment of the invention, the insulation rubber composition includes plasticizer having a wt % range of 15.95-16.03%. Moreover, in yet another exemplary embodiment of the invention, the insulation rubber composition includes one or more plasticizers having a wt % of 15.97-16.01%.

In the proposed insulation rubber composition, one or more blowing agents may be used to producing a cellular structure that reduces density, increases thermal and acoustic insulation, and increases relative stiffness. In particular, in an exemplary embodiment of the invention, the insulation rubber composition may include one or more blowing agents, including calcium oxide (CaO) and azodicarbonamide (ACD).

In an exemplary embodiment of the invention, the insulation rubber composition includes one or more blowing agents having a wt % range of 4.20-4.40%. In another exemplary embodiment of the invention, the insulation rubber composition includes one or more blowing agents having a wt % range of 4.25-4.35%. Moreover, in yet another exemplary embodiment of the invention, the insulation rubber composition includes one or more blowing agents having a wt % of 4.27-4.29%.

In the proposed insulation rubber composition, a curing agent may be used to toughen or harden the overall composition by cross-linking of polymer chains, using processes such as vulcanization. In an exemplary embodiment of the invention, the insulation rubber composition may include one or more curing agents, including zinc oxide, n-cyclohexyl-2-benzothiazole sulfenamide (CBS), diphenylguanidine (DPG), and sulfur (S).

In an exemplary embodiment of the invention, the insulation rubber composition includes one or more curing agents having a wt % range of 4.50-4.80%. In another exemplary embodiment of the invention, the insulation rubber composition includes one or more curing agents having a wt % range of 4.60-4.75%. Moreover, in yet another exemplary embodiment of the invention, the insulation rubber composition includes one or more curing agents having a wt % of 4.70-4.72%.

In the proposed insulation rubber composition, filler is used to complete the composition with respect to the other parts. In particular, in an exemplary embodiment of the invention, the insulation rubber composition may include calcium carbonate as a filler. In the proposed insulation rubber composition, calcium carbonate may have a wt % range of 14.20-14.40%. In another exemplary embodiment of the invention, the insulation rubber composition includes filler having a wt % range of 14.24-14.32%. In yet another exemplary embodiment of the invention, the insulation rubber composition includes filler having a wt % range of 14.26-14.30%.

The insulation rubber composition according to the invention may also include an antioxidant agent.

In the proposed insulation rubber composition, the antioxidant is used to prevent oxidation. In an exemplary embodiment of the invention, the insulation rubber composition may include one or more antioxidants, including butylated hydroxytoluene (BHT) and/or 2,2,4-trimethyl-1,2-dihydroquinoline polymer (TMQ).

In the proposed insulation rubber composition, one or more antioxidants may have a wt % range of 0.10-0.20%. In another exemplary embodiment of the invention, the insulation rubber composition includes one or more antioxidants having a wt % range of 0.12-0.15%. In yet another exemplary embodiment of the invention, the insulation rubber composition includes one or more antioxidants having a wt % range of 0.13-0.14%.

The present invention can be illustrated by the following examples without being limited by them. Each of the following examples was prepared being dependent on a required size of the annular tire 10 according to the invention.

Table 9 shows an exemplary embodiment of the insulation rubber composition.

TABLE 9
Exemplary Insulation Rubber Composition

| Component | Wt % |
|---|---|
| 1st Elastomer | 14.26% |
| 2nd Elastomer | 14.26% |
| 3rd Elastomer | 11.41% |
| Carbon Black | 20.59% |
| Filler | 14.26% |
| Plasticizer | 15.97% |
| Curing Agent | 4.70% |
| Blowing Agent | 4.27% |
| Antioxidant | 0.14% |

Table 10 shows another exemplary embodiment of the insulation rubber composition according to the invention.

TABLE 10
Exemplary Insulation Rubber Composition

| Additive | Component | Wt % |
|---|---|---|
| Ethylene Propylene Diene Monomer rubber | 1st Elastomer | 14.26% |
| (EPDM) | | |
| Natural polyisoprene rubber | 2nd Elastomer | 14.26% |
| High Styrene Rubber | 3rd Elastomer | 11.41% |
| Carbon Black | Carbon Black | 20.59% |
| Calcium Carbonate | Filler | 14.26% |
| Paraffin Oil | Plasticizer | 15.97% |
| Stearic Acid | Plasticizer | |
| Zinc Oxide | Curing Agent | 4.70% |
| N-Cyclohexyl-2-Benzothiazole Sulfenamide | Curing Agent | |
| (CBS or CZ) | | |
| Diphenylguanidine (DPG) | Curing Agent | |
| Sulfur (S) | Curing Agent | |
| Calcium Oxide (CaO) | Blowing Agent | 4.27% |
| Azodicarbonamide (ACD) | Blowing Agent | |
| Butylated hydroxytoluene (BHT) | Antioxidant | 0.14% |

Table 11 shows another exemplary embodiment of the insulation rubber composition according to the invention.

TABLE 11
Exemplary Insulation Rubber Composition

| Component | Wt % |
|---|---|
| 1st Elastomer | 14.30% |
| 2nd Elastomer | 14.30% |
| 3rd Elastomer | 11.43% |
| Carbon Black | 20.65% |
| Filler | 14.30% |
| Plasticizer | 16.01% |
| Curing Agent | 4.72% |
| Blowing Agent | 4.29% |
| Antioxidant | 0.14% |

Table 12 shows an exemplary embodiment of the insulation rubber composition according to the invention.

TABLE 12
Exemplary Insulation Rubber Composition

| Additive | Component | Wt % |
|---|---|---|
| Ethylene Propylene Diene Monomer rubber | 1st Elastomer | 14.30% |
| (EPDM) | | |
| Natural polyisoprene rubber | 2nd Elastomer | 14.30% |
| High Styrene Rubber | 3rd Elastomer | 11.43% |
| Carbon Black | Carbon Black | 20.65% |
| Calcium Carbonate | Filler | 14.30% |
| Paraffin Oil | Plasticizer | 16.01% |
| Stearic Acid | Plasticizer | |
| Zinc Oxide | Curing Agent | 4.72% |
| N-Cyclohexyl-2-Benzothiazole Sulfenamide | Curing Agent | |
| (CBS or CZ) | | |
| Diphenylguanidine (DPG) | Curing Agent | |
| Sulfur (S) | Curing Agent | |
| Calcium Oxide (CaO) | Blowing Agent | 4.29% |
| Azodicarbonamide (ACD) | Blowing Agent | |
| Butylated hydroxytoluene (BHT) | Antioxidant | 0.14% |

Table 13 shows another exemplary embodiment of the insulation rubber composition according to the invention.

TABLE 13
Exemplary Insulation Rubber Composition

| Component | Wt % |
|---|---|
| 1st Elastomer | 14.28% |
| 2nd Elastomer | 14.28% |
| 3rd Elastomer | 11.42% |
| Carbon Black | 20.62% |
| Filler | 14.28% |
| Plasticizer | 15.99% |
| Curing Agent | 4.71% |
| Blowing Agent | 4.28% |
| Antioxidant | 0.14% |

Table 14 shows another exemplary embodiment of the insulation rubber composition according to the invention.

TABLE 14
Exemplary Insulation Rubber Composition

| Additive | Component | Wt % |
|---|---|---|
| Ethylene Propylene Diene Monomer rubber | 1st Elastomer | 14.28% |
| (EPDM) | | |
| Natural polyisoprene rubber | 2nd Elastomer | 14.28% |
| High Styrene Rubber | 3rd Elastomer | 11.42% |
| Carbon Black | Carbon Black | 20.62% |
| Calcium Carbonate | Filler | 14.28% |
| Paraffin Oil | Plasticizer | 15.99% |
| Stearic Acid | Plasticizer | |
| Zinc Oxide | Curing Agent | 4.71% |
| N-Cyclohexyl-2-Benzothiazole Sulfenamide | Curing Agent | |
| (CBS or CZ) | | |
| Diphenylguanidine (DPG) | Curing Agent | |
| Sulfur (S) | Curing Agent | |
| Calcium Oxide (CaO) | Blowing Agent | 4.28% |
| Azodicarbonamide (ACD) | Blowing Agent | |
| Butylated hydroxytoluene (BHT) | Antioxidant | 0.14% |

A description on how to manufacture an exemplary annular solid insulation tube 30 according to the invention will be described.

A rubber composition according to the invention is processed according to the following steps. However, one skilled in the art should appreciate that following steps are merely exemplary and used to enable one skilled in the art to process the proposed insulation rubber compositions according to the invention.

Firstly, the components of the insulation rubber composition are measured according to the specifications defined above.

In an embodiment of the invention, a first combination of the first elastomer, the second elastomer, carbon black, one or more plasticizers, and the filler is mixed using a closed mixing system.

Next, the first combination is moved to an open mixing system where other components are added, including one or more curing agents, one or more blowing agents, and one or more antioxidants. The components mixed with the first combination provide a batch of the insulation rubber composition for further processing.

The batch is then added to an extruder for extrusion. The batch is extruded to a profile and size required for an annular tire 10 according to the invention. The batch travels along a chamber that is heated at different temperatures along different zones by a screw. In an embodiment of the invention, the first zone is heated to a temperature ranging from 200-220° C., the second zone is heated to a temperatures ranging from 160-185° C., and the third zone is heated to a temperature ranging from 170-190° C.

After the batch has been sheared and heated, the batch then travels through a die providing a profile of the annular tire 10 according to the invention. This includes the inner wall receiving section 34 and the inner tube receiving section 36.

A jig is used to cut a length of the extruded rubber composition, wherein the length and profile depend on the particular manufacturing-based required specifications of the annular tire 10 according to the invention. The cut is performed on a 45 degree or a 90 degree angle with respect to an outer surface of the extruded material.

After cutting, a solid cylindrical section is provided with opposite ends having a 45 degree or 90 degree profile. The opposite ends are then joined using a compression machine and the solid cylindrical section is formed into a solid ring of the insulation rubber composition according to the invention.

Referring to Figures, in which like reference numerals are used with regard to like elements, a pneumatic tire assembly 1, constructed in accordance with the present invention, will be described.

As shown, the annular solid insulation tube 30 is positioned between annular tire 10 and annular inflatable inner tube 20, wherein the outer surface 30b in contact with inner surface 10b of annular tire 10 and the inner tube receiving section 36 receives the outer surface 20b of the annular inflatable inner tube 20.

As air enters into the elastomeric hollow body 22 through the valve 24, the air puts pressure on the inner surface 20a which expands the elastomeric hollow body 22. The elastomeric hollow body 22 then forms to the inner tube receiving section 36.

The a bead section 16 engages the wheel 40 and as the body further expands, the inner wall receiving section 34 urges the bead section 16 down and outward against the wheel 40.

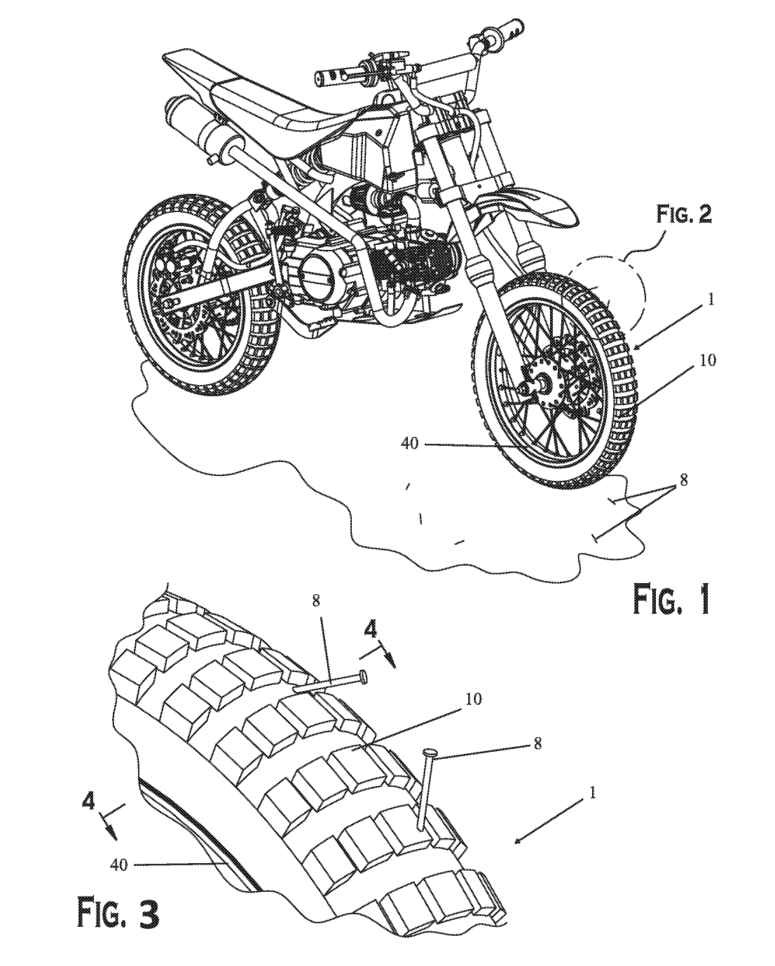

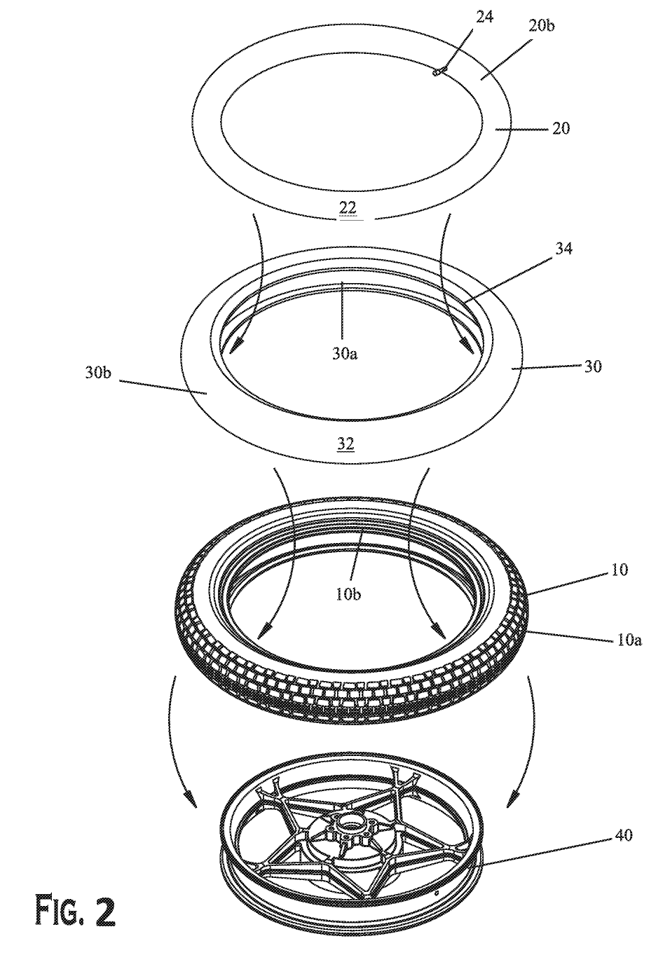

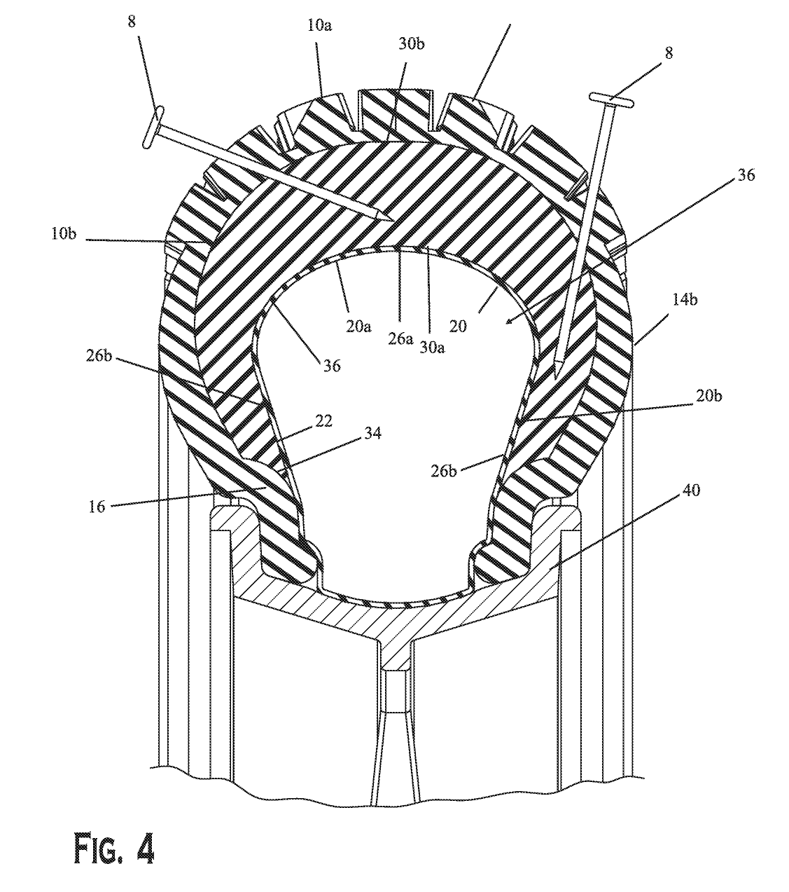

As shown in FIGS. 3 and 4, if a sharp object penetrates through the annular tire 10 and the annular inflatable inner tube 20, the inner tube 12 could fail and cause injury because the inner tube 12 is so thin and subject to penetration. However, as illustrated in FIGS. 2, 3, and 4, with an annular inflatable inner tube 20, separated from annular tire 10 by annular solid insulation tube 30, the annular inflatable inner tube 20 is protected to a certain extent from penetration by sharp foreign objects (nails in and screws) that penetrate the annular tire. Such sharp foreign objects that penetrate annular tire 10 at an and have a short length dead-end in annular solid insulation tube 30 as illustrated in FIGS. 2, 3, and 4. In the absence of annular solid insulation tube 30, nails and screws 8 would puncture the annular inflatable inner tube 20. In other words, the size of the sharp foreign object and the angle that it penetrates annular tire 10 are factors that determine whether annular solid insulation tube 30 protects annular inflatable inner tube 20 from penetration by the sharp foreign object.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A pneumatic tire assembly, comprising:
an annular tire having a tire outer surface and a tire inner surface;
an inflatable inner tube positioned within the annular tire and having a tube inner surface and a tube outer surface; and
an annular solid insulation tube positioned between the annular tire and the inflatable inner tube and having:
an outer surface in contact with the tire inner surface, and
an inner surface in contact with the tube outer surface.

2. The pneumatic tire assembly according to claim 1, wherein the annular solid insulation tube includes a solid body made from an insulation rubber composition.

3. The pneumatic tire assembly according to claim 2, wherein the solid body includes an inner tube receiving section positioned along the inner surface and extending into the solid body.

4. The pneumatic tire assembly according to claim 3, wherein the inflatable inner tubes forms to an inner shape of the inner tube receiving section made by the inner surface.

5. The pneumatic tire assembly according to claim 4, wherein the inner tube receiving section includes a top wall and a pair of side walls extending downward from the top wall and angled toward an axis separating two halves of the solid body.

6. The pneumatic tire assembly according to claim 5, wherein the solid body includes an inner wall receiving section positioned along the outer surface.

7. The pneumatic tire assembly according to claim 6, wherein the inner wall receiving section is hemispherical.

8. The pneumatic tire assembly according to claim 6, wherein annular tire includes a bead section urged against the inner wall receiving section.

9. The pneumatic tire assembly according to claim 8, wherein the bead section is received by the inner wall receiving section.

10. The pneumatic tire assembly according to claim 1, wherein the tire outer surface has a first section that is treaded and a second section that is even and continuous.

11. The pneumatic tire assembly according to claim 2, wherein the insulation rubber composition includes rubber composition includes:
an elastomer at about 39.00 to about 42.00 wt %;
carbon black at about 20.00 to about 23.00 wt %;
a plasticizer at about 13.70 to about 20.10 wt %;
a blowing agent at about 4.20 to about 4.40 wt %; and
a balance of a filler and incidental impurities.

12. The pneumatic tire assembly according to claim 2, wherein the insulation rubber composition includes a rubber composition that includes an elastomer, carbon black, a plasticizer, and a blowing agent.

13. The pneumatic tire assembly according to claim 12, wherein the elastomer is a saturated or unsaturated rubber.

14. The pneumatic tire assembly according to claim 12, wherein the elastomer includes a first elastomer and a second elastomer selected from a group of elastomers, consisting of: an ethylene propylene diene monomer rubber (EPDM), a natural polyisoprene rubber, a chloroprene rubber (CR), a styrene-butadiene rubber (SBR), and a nitrile rubber (NBR).

15. The pneumatic tire assembly according to claim 14, wherein the elastomer further includes a third elastomer.

16. The pneumatic tire assembly according to claim 15, wherein the first elastomer is an ethylene propylene diene monomer rubber (EPDM).

17. The pneumatic tire assembly according to claim 16, wherein the second elastomer is a natural polyisoprene rubber.

18. The pneumatic tire assembly according to claim 17, wherein the third elastomer is a high styrene rubber.

19. The pneumatic tire assembly according to claim 15, wherein the first elastomer is provided at about 14.00 to about 15.00 wt %.

20. The pneumatic tire assembly according to claim 19, wherein the second elastomer is provided at about 14.00 to about 15.00 wt %.

21. The pneumatic tire assembly according to claim 20, wherein the third elastomer is provided at about 11.00 to about 12.00 wt %.
